(19) United States
(12) Patent Application Publication
(10) Pub. No.: US 2014/0288819 A1
(43) Pub. Date: Sep. 25, 2014

(54) NAVIGATION SYSTEM AND CONTROL METHOD

(71) Applicant: Yuki Kita, Nerima-ku (JP)

(72) Inventor: Yuki Kita, Nerima-ku (JP)

(73) Assignee: PIONEER CORPORATION, Kanagawa (JP)

(21) Appl. No.: 14/360,773

(22) PCT Filed: Dec. 1, 2011
(86) PCT No.: PCT/JP2011/077786

§ 371 Date: May 27, 2014

(51) Int. Cl. G01C 21/10; G01C 21/00

(52) U.S. Cl. CPC G01C 21/10; G01C 21/00
USPC 701/409

(57) ABSTRACT

A navigation system includes: a sensor unit which is mounted on a movable body and which includes a first position obtaining unit that obtains first position information; and a portable movable unit which communicates with the sensor unit and which includes a display unit that displays map information and a second position obtaining unit that obtains second position information. The navigation system performs navigation by using the second position information obtained from the second position obtaining unit until a first predetermined time passes after the sensor unit is activated, and performs the navigation by using the first position information obtained from the first position obtaining unit after the first predetermined time passes.

### TECHNICAL FIELD

The present invention relates to a technical field of utilizing a GPS (Global Positioning System).

### BACKGROUND TECHNIQUE

Recently, a potable terminal device such as a high-functioning mobile phone called “smart phone” is installed and used in a movable body such as a vehicle. For the smart phone, there are proposed applications similar to a navigation device, and the smart phone can be installed in a vehicle to be used as a navigation device. For example, a Patent Reference 1 discloses a technique of realizing a high-accuracy navigation function, in which a terminal device is held by a terminal holding device including a sensor such as a gyro sensor and an output of the sensor provided in the terminal holding device is supplied to the terminal device.

Patent Reference 1: Japanese Patent No. 4827996

### DISCLOSURE OF INVENTION

### Problem to be Solved by the Invention

By the way, in a system including a terminal device (a movable unit) and a terminal holding device (a sensor unit) as described above, there may be a case that a GPS receiver is installed in both of the terminal device and the terminal holding device. There is a tendency that the terminal holding device can obtain position information more accurately than the terminal device because the terminal holding device is installed with a gyro sensor and an acceleration sensor in addition to the GPS receiver. Therefore, in the terminal device, it is desired to perform the navigation, not based on the position information obtained by the built-in GPS receiver, but based on the position information obtained by the terminal holding device.

In the terminal holding device, there is a tendency that the GPS receiver takes a certain period of time from its activation (start-up) to normally receive data. Therefore, at the activation of the terminal holding device, the accuracy of the position information obtained by the terminal holding device becomes low, and there may be a case that the navigation cannot be appropriately performed.

The above is an example of problems to be solved by the present invention. It is an object of the present invention to provide a navigation system and a control method capable of performing navigation by using appropriate position information at an activation of a sensor unit.

### Means for Solving the Problem

One invention is a navigation system comprising: a sensor unit which is mounted on a movable body and which includes a first position obtaining unit that obtains first position information; and a portable movable unit which communicates with the sensor unit and which includes a display unit that displays map information and a second position obtaining unit that obtains second position information, wherein the movable unit performs navigation by using the second position information obtained from the second position obtaining unit until a first predetermined time passes after the sensor unit is activated, and performs the navigation by using the first position information obtained from the first position obtaining unit after the first predetermined time passes.

Another invention is a control method executed by a navigation system comprising: a sensor unit which is mounted on a movable body and which includes a first position obtaining unit that obtains first position information; and a portable movable unit which communicates with the sensor unit and which includes a display unit that displays map information and a second position obtaining unit that obtains second position information, the method comprising a navigation process which performs navigation by using the second position information obtained from the second position obtaining unit until a first predetermined time passes after the sensor unit is activated, and performs the navigation by using the first position information obtained from the first position obtaining unit after the first predetermined time passes.

Another invention is a navigation system comprising: a sensor unit which is mounted on a movable body and which includes a first position obtaining unit that obtains first position information; and a portable movable unit which communicates with the sensor unit and which includes a display unit that displays map information and a second position obtaining unit that obtains second position information, wherein the movable unit performs navigation by using the second position information obtained from the second position obtaining unit until a predetermined condition is satisfied after the sensor unit is activated.

Another invention is a control method executed by a navigation system comprising: a sensor unit which is mounted on a movable body and which includes a first position obtaining unit that obtains first position information; and a portable movable unit which communicates with the sensor unit and which includes a display unit that displays map information and a second position obtaining unit that obtains second position information, the method comprising a navigation process which performs navigation by using the second position information obtained from the second position obtaining unit until a predetermined condition is satisfied after the sensor unit is activated.

### BRIEF DESCRIPTION OF THE DRAWINGS

FIG. 1 is a block diagram illustrating a schematic configuration of a navigation system according to embodiments.

FIG. 2 is a flowchart illustrating a control method according to a first embodiment.

FIG. 3 is a flowchart illustrating a control method according to a second embodiment.

FIG. 4 is a flowchart illustrating a control method according to a third embodiment.

FIG. 5 is a flowchart illustrating a control method according to a fourth embodiment.

### DETAILED DESCRIPTION OF THE PREFERRED EMBODIMENTS

According to one aspect of the present invention, there is provided a navigation system comprising: a sensor unit which is mounted on a movable body and which includes a first position obtaining unit that obtains first position information; and a portable movable unit which communicates with the sensor unit and which includes a display unit that displays map information and a second position obtaining unit that obtains second position information, wherein the movable unit performs navigation by using the second position information obtained from the second position obtaining unit until a first predetermined time passes after the sensor unit is activated, and performs the navigation by using the first position information obtained from the first position obtaining unit after the first predetermined time passes.

The above navigation system is preferably used to perform route guidance (navigation) from a start point to a destination. The sensor unit is mounted on a movable body and includes a first position obtaining unit that obtains first position information. The movable unit is configured to communicate with the sensor unit and is portable, and includes a display unit that displays map information and a second position obtaining unit that obtains second position information. The movable unit basically performs the navigation by using the first position information obtained from the first position obtaining unit in the sensor unit. However, until a first predetermined time passes after the sensor unit is activated, the movable unit presumes that the first position obtaining unit in the sensor unit is not normally receiving data, and performs the navigation by using the second position information obtained from the second position obtaining unit. Then, after the first predetermined time passes, the movable unit presumes that the first position obtaining unit is normally receiving data, and performs the navigation by using the first position information obtained from the first position obtaining unit. Thus, it is possible to appropriately perform the navigation, at the time of activating the sensor unit, by using position information of relatively high accuracy, without increasing the cost of the sensor unit (i.e., without the need of adding hardware, etc.).

In one mode of the above navigation system, the sensor unit includes an acceleration sensor, and the movable unit performs the navigation by using the second position information obtained from the second position obtaining unit and a signal outputted by the acceleration sensor, until the first predetermined time passes after the sensor unit is activated.

In this mode, the movable unit performs the navigation by using the position information obtained by correcting the second position information by the acceleration. Thus, it is possible to perform the navigation more appropriately by using the position information of higher accuracy.

In another mode of the above navigation system, the movable unit performs the navigation by using the first position information obtained from the first position obtaining unit when a second predetermined time has not passed since the second position obtaining unit is activated, even if the first predetermined time has not passed.

In this mode, at the time of activating the second position obtaining unit, the movable unit can perform the navigation by using the first position information obtained from the first position obtaining unit in the sensor unit, even if the first predetermined time has not passed. This is because, at the time of activating the sensor unit and the second position obtaining unit, the first position information is considered to be more accurate than the second position information.

In still another mode of the above navigation system, the movable unit includes a switching unit that switches between a state in which the second position obtaining unit is activated and a state in which the second position obtaining unit is not activated, and the movable unit performs the navigation by using the first position information obtained from the first position obtaining unit when the second position obtaining unit is not usable, even if the first predetermined time has not passed.

In this mode, since the movable unit cannot obtain the second position information when the second position obtaining unit is not usable, the movable unit can perform the navigation by using the first position information obtained from the first position obtaining unit in the sensor unit even if the first predetermined time has not passed.

Preferably, the sensor unit is activated at a time when the movable body on which the sensor unit is mounted is activated.

According to another aspect of the present invention, there is provided a control method executed by a navigation system comprising: a sensor unit which is mounted on a movable body and which includes a first position obtaining unit that obtains first position information; and a portable movable unit which communicates with the sensor unit and which includes a display unit that displays map information and a second position obtaining unit that obtains second position information, the method comprising a navigation process which performs navigation by using the second position information obtained from the second position obtaining unit until a first predetermined time passes after the sensor unit is activated, and performs the navigation by using the first position information obtained from the first position obtaining unit after the first predetermined time passes.

According to still another aspect of the present invention, there is provided a navigation system comprising: a sensor unit which is mounted on a movable body and which includes a first position obtaining unit that obtains first position information; and a portable movable unit which communicates with the sensor unit and which includes a display unit that displays map information and a second position obtaining unit that obtains second position information, wherein the movable unit performs navigation by using the second position information obtained from the second position obtaining unit until a predetermined condition is satisfied after the sensor unit is activated.

In the above navigation system, the movable unit performs the navigation by using the second position information obtained from the second position obtaining unit until a predetermined condition is satisfied after the sensor unit is activated. In this case, the movable unit performs the determination by using the predetermined condition, thereby to determine whether or not the first position obtaining unit is normally receiving the data. Also by the above navigation system, it is possible to appropriately perform the navigation, at the time of activating the sensor unit, by using position information of relatively high accuracy, without increasing the cost of the sensor unit (i.e., without the need of adding hardware, etc.).

In one mode of the above navigation system, the predetermined condition includes such a condition that a number of satellites transmitting signals received by the first position obtaining unit is equal to or larger than a predetermined value. In this mode, the movable unit can perform the navigation by using the second position information after the sensor unit is activated and until the number of the satellites transmitting the signal received by the first position obtaining unit becomes equal to or larger than the predetermined value.

In another mode of the above navigation system, the predetermined condition includes such a condition that a number of satellites transmitting signals received by the first position obtaining unit is equal to or larger than the number of satellites transmitting signals received by the second position obtaining unit. In this mode, the movable unit can perform the navigation by using the second position information after the sensor unit is activated and until the number of the satellites transmitting the signals received by the first position obtaining unit becomes equal to or larger than the number of satellites transmitting the signals received by the second position obtaining unit.

In still another mode of the above navigation system, the predetermined condition includes such a condition that a signal receiving state of the first position obtaining unit is better than the signal receiving state of the second position obtaining unit. In this mode, the movable unit can perform the navigation by using the second position information after the sensor unit is activated and until the signal receiving state of the first position obtaining unit becomes better than the signal receiving state of the second position obtaining unit.

Preferably, in the above navigation system, the predetermined condition is that one of the following conditions is satisfied: (1) a predetermined time has passed since the sensor unit is activated, (2) a number of satellites transmitting signals received by the first position obtaining unit is equal to or larger than a predetermined value, (3) a number of satellites transmitting signals received by the first position obtaining unit is equal to or larger than the number of satellites transmitting signals received by the second position obtaining unit, and (4) a signal receiving state of the first position obtaining unit is better than the signal receiving state of the second position obtaining unit.

According to still another aspect of the present invention, there is provided a control method executed by a navigation system comprising: a sensor unit which is mounted on a movable body and which includes a first position obtaining unit that obtains first position information; and a portable movable unit which communicates with the sensor unit and which includes a display unit that displays map information and a second position obtaining unit that obtains second position information, the method comprising a navigation process which performs navigation by using the second position information obtained from the second position obtaining unit until a predetermined condition is satisfied after the sensor unit is activated.

### EMBODIMENTS

Preferred embodiments of the present invention will be described below with reference to the attached drawings.

[Entire Configuration]

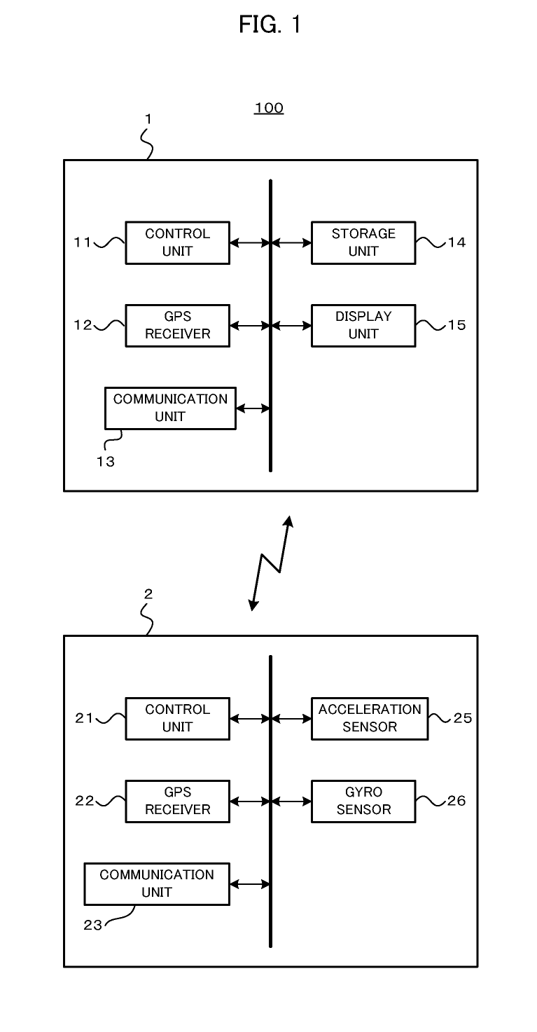

FIG. 1 is a block diagram illustrating a schematic configuration of a navigation system 100 according to embodiments. As shown in FIG. 1, the navigation system 100 includes a movable unit 1 and a sensor unit 2.

The movable unit 1 mainly includes a control unit 11, a CPS receiver 12, a communication unit 13, a storage unit 14 and a display unit 15. The movable unit 1 is a portable terminal device having a telephone call function, such as a smart phone. Also, the movable unit 1 has a function of performing route guidance (navigation) from a start point to a destination, for example. It is noted that the movable unit 1 includes an operation unit operated by a user, a communication unit for communication with other movable units 1, a speaker and a microphone, which are not shown, in addition to the constitutional elements shown in FIG. 1.

The GPS receiver 12 receives radio waves carrying downlink data including measurement data from a plurality of GPS satellites via an antenna not shown. The data received by the GPS receiver 12 is used to obtain position information of a current position (corresponding to “second position information” in the present invention). The GPS receiver 12 corresponds to an example of “a second position obtaining unit” in the present invention. The GPS receiver 12 can switch between an activated state and an unactivated state by the user's operation, and a switch or an interface for the switching operation corresponds to an example of “a switching unit” of the present invention.

The communication unit 13 is configured to be able to perform wireless communication with the sensor unit 2 (specifically, a communication unit 23 in the sensor unit 2). For example, the communication unit 13 performs the wireless communication by utilizing Bluetooth (Registered Trademark).

The display unit 15 is configured by a Liquid Crystal Display, for example, and displays characters and/or images to the user. In an example, the display unit 15 displays map information.

The storage unit 14 includes a ROM and a RAM. The storage unit 14 stores various control programs for controlling the movable unit 11 and provides a working area for the control unit 11.

The control unit 11 includes a CPU, and controls the movable unit 1 in its entirety. For example, the control unit 11 performs processing for the route guidance from a start point to a destination. In this case, the control unit 11 performs the matching processing (a processing of matching the position of the position information on a road by using road shape data of the map data), and performs the route guidance to the user by displaying the guide route on the map in accordance with the position after the map matching processing.

On the other hand, the sensor unit 2 mainly includes a control unit 21, a GPS receiver 22, a communication unit 23, an acceleration sensor 25 and a gyro sensor 26. The sensor unit 2 is mounted on a movable body such as a vehicle (e.g., fixed on a dashboard of the vehicle), and is configured to hold the movable unit 1. The sensor unit 2 corresponds to an on-vehicle device such as a cradle. In a case of using the movable unit 1 in the vehicle, it is not limited to use the movable unit 1 in a state being fixed on the sensor unit 2.

The GPS receiver 22 receives radio waves carrying downlink data including measurement data from a plurality of GPS satellites via an antenna not shown. The data received by the GPS receiver 22 is used to obtain position information of a current position. The GPS receiver 22 corresponds to an example of “a first position obtaining unit” in the present invention.

The communication unit 23 is configured to perform wireless communication with the movable unit 1 (specifically, the communication unit 13 in the movable unit 1). For example, the communication unit 23 performs the wireless communication by utilizing Bluetooth (Registered Trademark).

The acceleration sensor 25 detects an acceleration of the vehicle, and outputs the acceleration data. The gyro sensor 26 detects an angular velocity in a yaw direction at the time that the vehicle turns its direction, and outputs the angular velocity data. The acceleration and the angular velocity detected by the acceleration sensor 25 and the gyro sensor 26 are supplementarily used to obtain the position information of the current position.

The control unit 21 is configured to have a CPU, and controls the sensor unit 2 in its entirety. For example, the control unit 21 performs the processing to obtain the position information of the current position (corresponding to “the first position information” in the present invention) based on the data obtained from the GPS receiver 22 and the various sensors described above. Then, the control unit 21 transmits the position information thus obtained to the movable unit 1 via the communication unit 23.

It is noted that “the position information” described above is information including latitude, longitude, velocity, altitude, a direction and acceleration.

[Control Method]

Next, the control method in the embodiments will be specifically described. Here, the basic concept of the control method of the embodiments will be described.

As described above, in the navigation system 100, both the movable unit 1 and the sensor unit 2 include the GPS receiver (GPS receivers 12, 22). Normally, the movable unit 1 performs the navigation and the map display by using, not the position information (hereinafter conveniently referred to as “second position information”) obtained from the data received by the built-in GPS receiver 12, but the position information (hereinafter conveniently referred to as “first position information”) obtained from the data received by the GPS receiver 22 in the sensor unit 2. This is because the sensor unit 2 tends to include a circuit for processing the data received by the GPS receiver and a GPS antenna having higher accuracy than those provided in the movable unit 1. Also, since the sensor unit 2 uses the acceleration and the angular velocity detected by the acceleration sensor 25 and the gyro sensor 26, it can obtain the first position information accurately.

For example, the movable unit 1 uses the second position information obtained from the data received by the built-in GPS receiver 12 before the communication with the sensor unit 2 is established, and uses the first position information obtained from the data received by the GPS receiver 22 in the sensor unit 2 after the communication with the sensor unit 2 is established. Namely, the movable unit 1 switches the position information to be used, from the second position information to the first position information, when the communication with the sensor unit 2 is established.

By the way, the sensor unit 2 does not have a battery, and operates based on the electric power supplied from the accessory power supply in the vehicle. Therefore, the sensor unit 2 is powered on when the vehicle is activated, and powered off when the vehicle is stopped. In this case, when the vehicle is activated and the electric power is supplied to the sensor unit 2 (i.e., at the time of activation of the sensor unit 2), the accuracy of the first position information obtained from the data received by the GPS receiver 22 in the sensor unit 2 may be low (or sometimes the first position information itself cannot be obtained). This is because the sensor unit 2 tends to require a certain time period (e.g., 30 seconds to several minutes) from its activation until it receives data normally.

A general navigation apparatus also has such a disadvantage. In order to overcome such a disadvantage, there are proposed various methods (so-called “hot start”) to shorten the time until the GPS receiver receives data normally. In an example, the position information immediately before the shutdown of the power supply is stored in a non-volatile memory before the shutdown of the power supply, and the position information thus stored is used at the time of the activation next time. In another example, after the power on, current time and/or positions of the satellites are obtained from a website, and the satellite information is presumed from those information. In still another example, satellite position information is obtained from a website (all satellite orbit is calculated in advance) to be stored in a non-volatile memory, and the satellite information is presumed from the information stored in the non-volatile memory at the time of next activation.

However, if the hot start methods as described above are applied to the sensor unit 2, it is necessary to add a non-volatile memory, a battery, a power supply instantaneous interruption detecting circuit, a hardware necessary for a third generation mobile communication system (3G) and a hardware for Wi-Fi (Wireless Fidelity) to the sensor unit 2, and hence the cost of the sensor unit 2 is increased. In this view, in the embodiments, the control is performed to appropriately cope with the time period until the GPS receiver 22 in the sensor unit 2 normally receives data without cost increase of the sensor unit 2 (i.e., without the need of adding hardware). Namely, the control that can achieve the same operation as the hot start is performed.

Specifically, in the embodiments, after the sensor unit 2 is activated and until the GPS receiver 22 in the sensor unit 2 normally receives data, the navigation is performed by using the second position information obtained from the data received by the GPS receiver 12 in the movable unit 1. Generally, the movable unit 1 has a built-in battery, and the power supply of the movable unit 1 is basically on at the time of performing the navigation in the vehicle. Therefore, during the period until the GPS receiver 22 in the sensor unit 2 normally receives data, the GPS receiver 12 in the movable unit 1 receives data, and the second position information is being constantly obtained based on the data. Accordingly, in the embodiments, it is assumed that the second position information obtained from the data received by the GPS receiver 12 is more accurate than the first position information obtained from the data received by the GPS receiver 22 in the sensor unit 2 at the time of activation of the sensor unit 2, and the movable unit 1 performs the navigation by using the second position information obtained from the data received by the built-in GPS receiver 12.

By the embodiments, it is possible to appropriately perform the navigation by using the position information of relatively high accuracy at the time of activation of the sensor unit 2, without the cost increase of the sensor unit 2 (i.e., without adding hardware). Namely, it is possible to perform the navigation by appropriately using the second position information whose accuracy is higher than the first position information obtained by the sensor unit 2.

In the following, description will be given of embodiments (first to fourth embodiments) related to the condition used to determine whether or not the GPS receiver 22 in the sensor unit 2 is normally receiving the data. The determination of whether or not the GPS receiver 22 in the sensor unit 2 is normally receiving the data corresponds to the determination of an appropriate timing to switch the position information used for the navigation from the second position information to the first position information.

### 1st Embodiment

In the first embodiment, the movable unit 1 determines whether or not a predetermined time has passed since the sensor unit 2 is activated, thereby to determine whether or not the GPS receiver 22 in the sensor unit 2 is normally receiving the data. Specifically, the movable unit 1 determines that the GPS receiver 22 in the sensor unit 2 is normally receiving the data when the predetermined time has passed since the activation of the sensor unit 2, and determines that the GPS receiver 22 in the sensor unit 2 is not normally receiving the data when the predetermined time has not passed since the activation of the sensor unit 2. The predetermined time used in this determination corresponds to “a first predetermined time” in the present invention, and is preset in advance in accordance with a time necessary for the GPS receiver 22 in the sensor unit 2 to normally receive the data after the activation of the sensor unit 2.

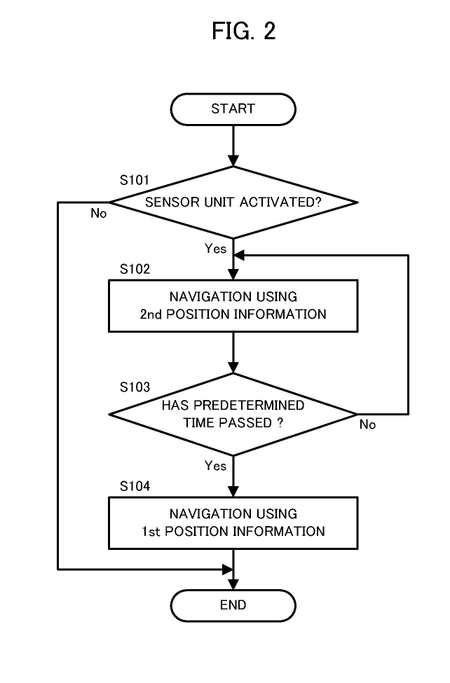

FIG. 2 is a flowchart showing the control method according to the first embodiment. This flow is executed by the control unit 11 in the movable unit 1.

First, in step S101, the control unit 11 in the movable unit 1 determines whether or not the sensor unit 2 is activated. Namely, the control unit 11 determines whether or not the sensor unit 2 is powered on. When the sensor unit 11 is powered on (step S101; Yes), the process goes to step S102. When the sensor unit 11 is not activated (step S101: No), the process ends.

In step S202, the control unit 11 performs the navigation by using the second position information obtained from the data received by the built-in GPS receiver 12. In this case, in one example, the control unit 11 obtains the second position information only from the data received by the built-in GPS receiver 12. In another example, the control unit 11 obtains the acceleration detected by the acceleration sensor 25 in the sensor unit 2 and/or the angular velocity detected by the gyro sensor 26 in the sensor unit 2, and obtains the second position information for the current position based on, not only the data received by the built-in GPS receiver 12, but also the acceleration and/or angular velocity thus obtained. In this example, the control unit 11 corrects the data received by the GPS receiver 12 with the acceleration and/or the angular velocity to obtain the second position information. Thus, the position information can be accurately obtained in comparison with the case where the second position information is obtained only from the data received by the GPS receiver 12. After step S102, the process goes to step S103.

In step S103, the control unit 11 determines whether or not the predetermined time has passed since the activation of the sensor unit 2. In this step S103, it is determined whether or not the GPS receiver 22 in the sensor unit 2 is normally receiving the data. In one example, the predetermined time used in the determination is set to a time generally necessary for the GPS receiver 22 to normally receive the data (e.g., 30 seconds). In another example, the predetermined time is set to several minutes with a margin, considering that sometimes it may take relatively long time for the GPS receiver 22 to normally receive the data.

When the predetermined time has passed since the activation of the sensor unit 2 (step S103: Yes), the process goes to step S104. In this case, the control unit 11 determines that the GPS receiver 22 in the sensor unit 2 is normally receiving the data, and performs the navigation by using the first position information obtained from the data received by the GPS receiver 22 in the sensor unit 2 (step S104). Namely, the control unit 11 switches the position information to be used from the second position information to the first position information. The first position information is the position information that the control unit 21 obtains based on the data received by the GPS receiver 22 and the acceleration detected by the acceleration sensor 25 and/or the angular velocity detected by the gyro sensor 26. After step S104, the process ends.

On the other hand, when the predetermined time has not passed since the activation of the sensor unit 2 (step S103: No), the process returns to step S102. In this case, the control unit 11 determines that the GPS receiver 22 in the sensor unit 2 is not normally receiving the data, and continues the navigation by using the second position information.

### 2nd Embodiment

In the second embodiment, the movable unit 1 determines whether or not the receiving satellite number of the GPS receiver 22 in the sensor unit 2 is equal to or larger than a predetermined value, thereby to determine whether or not the GPS receiver 22 in the sensor unit 2 is normally receiving the data. Specifically, the movable unit 1 determines that the GPS receiver 22 is normally receiving the data when the receiving satellite number of the GPS receiver 22 in the sensor unit 2 is equal to or larger than the predetermined value, and determines that the GPS receiver 22 in the sensor unit 2 is not normally receiving the data when the receiving satellite number of the GPS receiver 22 in the sensor unit 2 is smaller than the predetermined value.

For example, the predetermined value used in the determination of the receiving satellite number is set to the number of the satellites (i.e., four) necessary for the GPS receiver 22 in the sensor unit 2 to perform the three-dimensional measurement. In case of using this predetermined value, determining whether or not the receiving satellite number of the GPS receiver 22 in the sensor unit 2 is equal to or larger than the predetermined number corresponds to the determination of whether or not the GPS receiver 22 in the sensor unit 2 is performing the three-dimensional measurement.

It is noted that “the three-dimensional measurement” corresponds to the measurement of the position on the earth in three-dimensions, i.e., latitude, longitude and altitude, based on the radio waves from the GPS satellites. In order to achieve the three-dimensional measurement, it is necessary to receive the radio waves from four or more GPS satellites. When the radio waves can be received from only three GPS satellites, the two-dimensional measurement of latitude and longitude is performed.

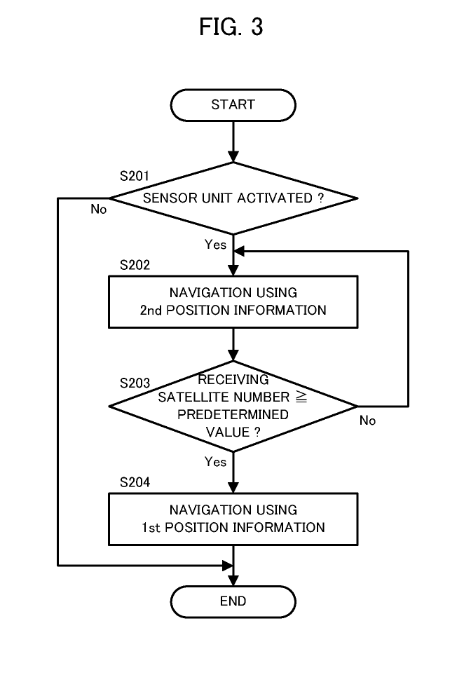

FIG. 3 is a flowchart showing the control method according to the second embodiment. This flow is executed by the control unit 11 in the movable unit 1.

Since the processing in steps S201, S202, S204 are the same as the processing of in steps S101, S102, S104 show in FIG. 2, the description thereof will be omitted. Here, only the processing in step S203 will be described.

In step S203, the control unit 11 in the movable unit 1 determines whether or not the receiving satellite number of the GPS receiver 22 in the sensor unit 2 is equal to or larger than the predetermined value. For example, the control unit 11 sets the predetermined value to “4” to determine whether or not the GPS receiver 22 in the sensor unit 2 is performing the three-dimensional measurement. It is not limited to set the predetermined value to “4”.

When the receiving satellite number is equal to or larger than the predetermined value (step S203: Yes), the control unit 11 determines that the GPS receiver 22 in the sensor unit 2 is normally receiving the data, and uses the first position information obtained from the data received by the GPS receiver 22 in the sensor unit 2 (step S204). On the other hand, when the receiving satellite number is smaller than the predetermined value (step S203: No), the control unit 11 determines that the GPS receiver 22 in the sensor unit 2 is not normally receiving the data, and uses the second position information obtained from the data received by the built-in GPS receiver 12 (step S202).

### 3rd Embodiment

In the third embodiment, the movable unit 1 determines whether or not the receiving satellite number of the GPS receiver 22 in the sensor unit 2 is equal to or larger than the receiving satellite number of the built-in GPS receiver 12, thereby to determine whether or not the GPS receiver 22 in the sensor unit 2 is normally receiving the data. Specifically, the movable unit 1 determines that the GPS receiver 22 in the sensor unit 2 is normally receiving the data when the receiving satellite number of the GPS receiver 22 in the sensor unit 2 is equal to or larger than the receiving satellite number of the built-in GPS receiver 12, and determines that the GPS receiver 22 in the sensor unit 2 is not normally receiving the data when the receiving satellite number of the GPS receiver 22 in the sensor unit 2 is smaller than the receiving satellite number of the built-in GPS receiver 12.

Determining whether or not the receiving satellite number of the GPS receiver 22 in the sensor unit 2 is equal to or larger than the receiving satellite number of the built-in receiver 12 corresponds to the determination of whether or not the first position information obtained from the data received by the GPS receiver 22 in the sensor unit 2 has higher accuracy than the second position information obtained from the data received by the built-in GPS receiver 12. Therefore, in third embodiment, the control unit 11 determines which one of the first position information and the second position information has higher accuracy based on the receiving satellite numbers of the GPS receivers 12, 22, thereby to switch the position information to be used.

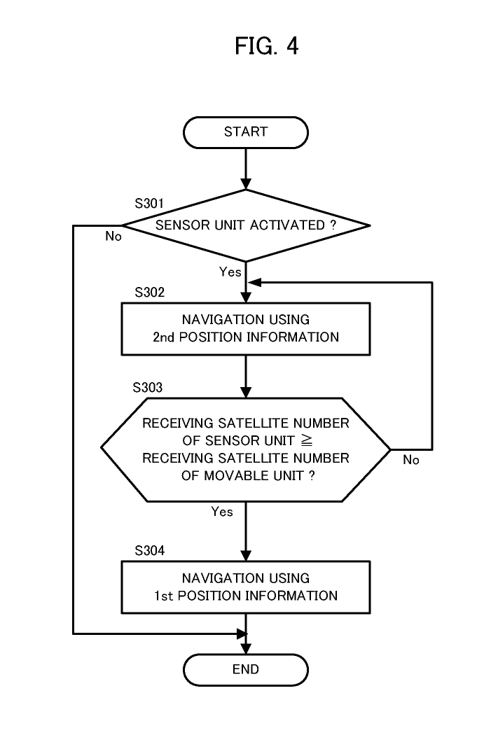

FIG. 4 is a flowchart showing the control method according to the third embodiment. This flow is executed by the control unit 11 in the movable unit 1.

Since the processing in steps S301, S302, S304 are the same as the processing in steps S101, S102, S104 shown in FIG. 2, the description thereof will be omitted. Here, only the processing in step S303 will be described.

In step S303, the control unit 11 in the movable unit 1 determines whether or not the receiving satellite number of the GPS receiver 22 in the sensor unit 2 is equal to or larger than the receiving satellite number of the built-in GPS receiver 12. In one example, as the receiving satellite number of the GPS receivers 12 and 22, the control unit 11 uses the number of the GPS satellite actually used for the measurement. In another example, as the receiving satellite number of the GPS receivers 12 and 22, the control unit 11 uses the number of all the GPS satellites being captured by the GPS receivers 12 and 22 (i.e., the receivable GPS satellites), regardless of whether they are actually being used for the measurement or not.

When the receiving satellite number of the GPS receiver 22 is equal to or larger than the receiving satellite number of the GPS receiver 12 (step S303: Yes), the control unit 11 determines that the GPS receiver 22 in the sensor unit 2 is normally receiving the data, and uses the first position information obtained by the data received by the GPS receiver 22 in the sensor unit 2 (step S304). On the other hand, when the receiving satellite number of the GPS receiver 22 in the sensor unit 2 is smaller than the receiving satellite number of the GPS receiver 12 (step S303: No), the control unit 11 determines that the GPS receiver 22 in the sensor unit 2 is not normally receiving the data, and uses the second position information obtained from the data received by the built-in GPS receiver 12 (step S302).

### 4th Embodiment

In the fourth embodiment, the movable unit 1 determines whether or not the receiving state of the signal (hereinafter referred to as “GPS signal receiving state”) of the GPS receiver 22 in the sensor unit 2 is better than the GPS signal receiving state of the built-in GPS receiver 12, thereby to determines whether or not the GPS receiver 22 in the sensor unit 2 is normally receiving the data. Specifically, the movable unit 1 determines that the GPS receiver 22 in the sensor unit 2 is normally receiving the data when the GPS signal receiving state of the GPS receiver 22 in the sensor unit 2 is better than the GPS signal receiving state of the built-in GPS receiver 12, and determines that the GPS receiver 22 in the sensor unit 2 is not normally receiving the data when the GPS signal receiving state of the GPS receiver 22 in the sensor unit 2 is worse than the GPS signal receiving state of the built-in GPS receiver 12.

Determining whether or not the GPS signal receiving state of the GPS receiver 22 in the sensor unit 2 is better than the GPS signal receiving state of the built-in GPS receiver 12 corresponds to the determination of whether or not the first position information obtained from the data received by the GPS receiver 22 in the sensor unit 2 has higher accuracy than the second position information obtained from the data received by the built-in GPS receiver 12. Therefore, in fourth embodiment, the control unit 11 determines which one of the first position information and the second position information has higher accuracy based on the GPS signal receiving state of the GPS receivers 12, 22, thereby to switch the position information to be used.

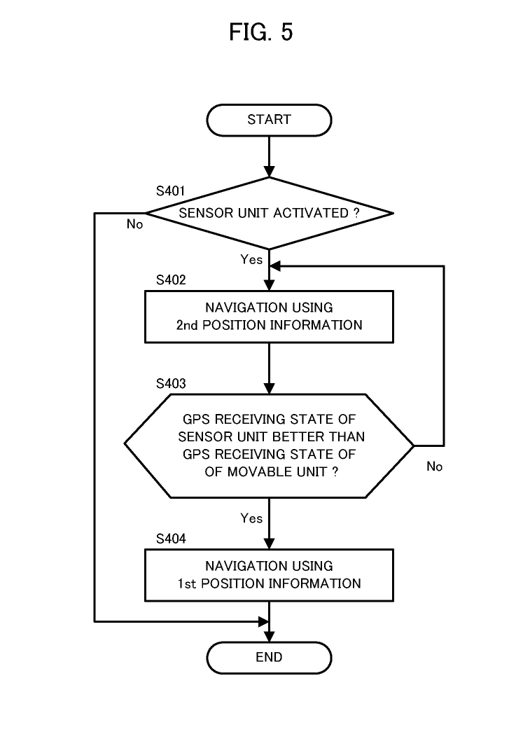

FIG. 5 is a flowchart showing the control method according to the fourth embodiment. This flow is executed by the control unit 11 in the movable unit 1.

Since the processing in steps S401, S402, S404 are the same as the processing in steps S101, S102, S104 shown in FIG. 2, the description thereof will be omitted. Here, only the processing in step S403 will be described.

In step S403, the control unit 11 in the movable unit 1 determines whether or not the GPS signal receiving state of the GPS receiver 22 in the sensor unit 2 is better than the GPS signal receiving state of the built-in GPS receiver 12. In one example, as the GPS signal receiving state, the control unit 11 uses the sensitivity of the signal receiving satellite in the GPS receivers 12, 22 (e.g., Signal to Noise ratio (SN ratio)). In this example, the control unit 11 determines the GPS signal receiving state by determining whether or not an average value of the signal receiving sensitivities of all the receiving satellites in the GPS receiver 22 in the sensor unit 2 is higher than an average value of the signal receiving sensitivities of all the receiving satellites in the built-in GPS receiver 12. In this case, as the signal receiving satellite, the GPS satellites being actually used for the measurement may be used, or all the GPS satellites being captured (i.e., the receivable satellites) may be used.

In another example, as the GPS signal receiving state, the control unit 11 uses the radio field intensity in the GPS receiver 22. In still another example, as the GPS signal receiving state, the control unit 11 uses the distance error (i.e., the measurement error) of the GPS.

When the GPS signal receiving state of the GPS receiver 22 is better than the GPS signal receiving state of the GPS receiver 12 (step S403: Yes), the control unit 11 determines that the GPS receiver 22 in the sensor unit 2 is normally receiving the data, and uses the first position information obtained from the data received by the GPS receiver 22 in the sensor unit 2 (step S404). On the other hand, when the GPS signal receiving state of the GPS receiver 22 is worse than the GPS signal receiving state of the GPS receiver 12 (step S403: No), the control unit 11 determines that the GPS receiver 22 in the sensor unit 2 is not normally receiving the data, and continues to use the second position information obtained from the data received by the built-in GPS receiver 12 (step S402).

### MODIFIED EXAMPLES

Hereinafter, modified examples preferred to the above embodiments will be described. The following modified examples may be applied to the above embodiments in a voluntary combination.

### 1st Modified Example

Whether or not the GPS receiver 22 in the sensor unit 2 is normally receiving the data may be determined by using the combination of at least two of the conditions described in the first to fourth embodiments. Specifically, the movable unit 1 may use two or more of the following conditions:

(1) A predetermined time has passed since the sensor unit 2 is activated.

(2) The receiving satellite number of the GPS receiver 22 in the sensor unit 2 is equal to or larger than the predetermined value.

(3) The receiving satellite number of the GPS receiver 22 in the sensor unit 2 is larger than the receiving satellite number of the GPS receiver 12 in the movable unit 1.

(4) The GPS signal receiving state of the GPS receiver 22 in the sensor unit 2 is better than the GPS signal receiving state of the GPS receiver 12 in the movable unit 1.

For example, when one of two or more conditions is satisfied, the movable unit 1 may determine that the GPS receiver 22 in the sensor unit 2 is normally receiving the data and switch the position information used for the navigation from the second position information to the first position information.

### 2nd Modified Example

In the above embodiments, the second position information obtained from the data received by the GPS receiver 12 in the movable unit 1 is used only at the time of the activation of the sensor unit 2. However, the second position information may be used at the time other than the activation of the sensor unit 2. Specifically, at the time other than the activation of the sensor unit 2, the movable unit 1 may perform the navigation by using the second position information in the case where the second position information has higher accuracy than the first position information. As the case where the second position information has higher accuracy than the first position information, there is a case where the vehicle is running in the area such as a tunnel in which the GPS receiver is difficult to receive the radio waves (in this case, the second position information does not necessarily have the accuracy higher than the first position information), or a case where the sensor unit 2 has a malfunction. Whether or not the second position information has the accuracy higher than the first position information may be determined by using the same conditions as the conditions described above.

According to the second modified example, when the second position information has higher accuracy than the first position information, the second position information can be appropriately used to enhance robustness.

### 3rd Modified Example

When the GPS receiver 12 in the movable unit 1 cannot be used, even if the above-described condition is not satisfied, the first position information obtained by the sensor unit 2 can be used. In one example, when the user invalidates the GPS receiver 12 in the movable unit 1 by manual operation to save electricity (i.e., the GPS receiver 12 is set to the unactivated state by the switching means), the GPS receiver 12 cannot receive the data and the appropriate second position information cannot be obtained. Therefore, the movable unit 1 may constantly use the first position information obtained by the sensor unit 2. Thus, an appropriate position information can be used with giving the priority to the user's setting.

In another example, in the case where the vehicle starts from the underground car park, the GPS receiver 12 in the movable unit 1 cannot receive the data and the appropriate second position information cannot be obtained. Therefore, the movable unit 1 may constantly use the first position information obtained by the sensor unit 2. In this example, the GPS receiver 22 in the sensor unit 2 cannot receive the data either. However, since the sensor unit 2 can obtain the first position information based on the acceleration and/or the angular velocity, the movable unit 1 regards the first position information to have higher accuracy than the second position information, and uses the first position information obtained by the sensor unit 2.

### 4th Modified Example

At the time of activating the movable unit 1, even if the above condition is not satisfied, the first position information obtained by the sensor unit 2 can be used. Specifically, in the case where a predetermined time (corresponding to “the second predetermined time” in the present invention) has not passed since the activation of the movable unit 1, it is presumed that the GPS receiver 12 in the movable unit 1 is not normally receiving the data. Therefore, the movable unit 1 may use the first position information obtained by the sensor unit 2 even if the predetermined time (the first predetermined time) has not passed since the activation of the movable unit 1. This is because, the sensor unit 2 can obtain the first position information based on the acceleration and/or the angular velocity, and therefore the first position information is presumed to have higher accuracy than the second position information at the time of activating the movable unit 1 and the sensor unit 2. It is noted that the predetermined time (the second predetermined time) used in the determination at the time of the activation of the movable unit 1 is set in advance in accordance with the time necessary for the GPS receiver 12 in the movable unit 1 to normally receive the data after the activation of the movable unit 1.

By using the first position information at the time of activating the movable unit 1, the navigation can be performed by using the appropriate position information.

### 5th Modified Example

The above description shows the embodiments in which the movable unit 1 and the sensor unit 2 communicate information by the wireless communication. However, the movable unit 1 and the sensor unit 2 may communicate information by cable communication. Namely, the movable unit 1 and the sensor unit 2 may be wired to perform information communication.

### 6th Modified Embodiment

The above description shows the examples in which the movable unit according to the present invention is applied to a smart phone. However, the movable unit according to the present invention may be applied to a tablet and a game machine including a GPS receiver.

### INDUSTRIAL APPLICABILITY

This invention can be used for a system which performs navigation to a destination.

### DESCRIPTION OF REFERENCE NUMERALS

1 Movable unit
2 Sensor unit
11,21 Control unit
12,22 GPS receiver
13,23 Communication unit
15 Display unit
25 Acceleration sensor
26 Gyro sensor

1. A navigation system comprising:
a sensor unit which is mounted on a movable body and which includes a first position obtaining unit that obtains first position information; and
a portable movable unit which communicates with the sensor unit and which includes a display unit that displays map information and a second position obtaining unit that obtains second position information,
wherein the movable unit performs navigation by using the second position information obtained from the second position obtaining unit until a first predetermined time passes after the sensor unit is activated, and performs the navigation by using the first position information obtained from the first position obtaining unit after the first predetermined time passes.

2. The navigation system according to claim 1,
wherein the sensor unit includes an acceleration sensor, and
wherein the movable unit performs the navigation by using the second position information obtained from the second position obtaining unit and a signal outputted by the acceleration sensor, until the first predetermined time passes after the sensor unit is activated.

3. The navigation system according to claim 1, wherein the movable unit performs the navigation by using the first position information obtained from the first position obtaining unit when a second predetermined time has not passed since the second position obtaining unit is activated, even if the first predetermined time has not passed.

4. The navigation system according to claim 1,
wherein the movable unit includes a switching unit that switches between a state in which the second position obtaining unit is activated and a state in which the second position obtaining unit is not activated, and
wherein the movable unit performs the navigation by using the first position information obtained from the first position obtaining unit when the second position obtaining unit is not usable, even if the first predetermined time has not passed.

5. The navigation system according to claim 1, wherein the sensor unit is activated at a time when the movable body on which the sensor unit is mounted is activated.

6. A control method executed by a navigation system comprising: a sensor unit which is mounted on a movable body and which includes a first position obtaining unit that obtains first position information; and a portable movable unit which communicates with the sensor unit and which includes a display unit that displays map information and a second position obtaining unit that obtains second position information,
the method comprising a navigation process which performs navigation by using the second position information obtained from the second position obtaining unit until a first predetermined time passes after the sensor unit is activated, and performs the navigation by using the first position information obtained from the first position obtaining unit after the first predetermined time passes.

7. A navigation system comprising:
a sensor unit which is mounted on a movable body and which includes a first position obtaining unit that obtains first position information; and
a portable movable unit which communicates with the sensor unit and which includes a display unit that displays map information and a second position obtaining unit that obtains second position information,
wherein the movable unit performs navigation by using the second position information obtained from the second position obtaining unit until a predetermined condition is satisfied after the sensor unit is activated.

8. The navigation system according to claim 7, wherein the predetermined condition includes such a condition that a number of satellites transmitting signals received by the first position obtaining unit is equal to or larger than a predetermined value.

9. The navigation system according to claim 7, wherein the predetermined condition includes such a condition that a number of satellites transmitting signals received by the first position obtaining unit is equal to or larger than the number of satellites transmitting signals received by the second position obtaining unit.

10. The navigation system according to claim 7, wherein the predetermined condition includes such a condition that a signal receiving state of the first position obtaining unit is better than the signal receiving state of the second position obtaining unit.

11. The navigation system according to claim 7, wherein the predetermined condition is that one of the following conditions is satisfied:
(1) a predetermined time has passed since the sensor unit is activated,
(2) a number of satellites transmitting signals received by the first position obtaining unit is equal to or larger than a predetermined value,
(3) a number of satellites transmitting signals received by the first position obtaining unit is equal to or larger than the number of satellites transmitting signals received by the second position obtaining unit, and
(4) a signal receiving state of the first position obtaining unit is better than the signal receiving state of the second position obtaining unit.

12. A control method executed by a navigation system comprising: a sensor unit which is mounted on a movable body and which includes a first position obtaining unit that obtains first position information; and a portable movable unit which communicates with the sensor unit and which includes a display unit that displays map information and a second position obtaining unit that obtains second position information,
the method comprising a navigation process which performs navigation by using the second position information obtained from the second position obtaining unit until a predetermined condition is satisfied after the sensor unit is activated.
